(19) United States
(12) Patent Application Publication
(10) Pub. No.: US 2014/0289615 A1
(43) Pub. Date: Sep. 25, 2014

(54) METHOD AND DEVICE FOR TYPESETTING

(71) Applicant: Xiaomi Inc., Beijing (CN)

(72) Inventor: Lei Zhang, Beijing (CN)

(73) Assignee: Xiaomi Inc., Beijing (CN)

(21) Appl. No.: 14/141,015

(22) Filed: Dec. 26, 2013

Related U.S. Application Data
(63) Continuation of application No. PCT/CN2013/084008, filed on Sep. 23, 2013.

(30) Foreign Application Priority Data
Mar. 19, 2013 (CN) 201310088577.8

(51) Int. Cl. G06F 17/21

(52) U.S. Cl. CPC G06F 17/214; G06F 17/217
USPC 715/251

(57) ABSTRACT

A method for a device to perform typesetting on a document, including: paginating the document into a plurality of pages; determining that a page of the plurality of pages contains a blank area after the paginating; determining an adjustable element in the document that causes the blank area; and transposing the adjustable element and an adjacent element in the document, to determine a typesetting sequence for the document.

### CROSS-REFERENCE TO RELATED APPLICATIONS

This application is a continuation of International Application No. PCT/CN2013/084008, filed Sep. 23, 2013, which is based upon and claims priority from Chinese Patent Application No. 201310088577.8, filed on Mar. 19, 2013, the entire contents of all of which are incorporated herein by reference.

### TECHNICAL FIELD

The present disclosure generally relates to the field of data processing and, more particularly, to a method and a device for typesetting.

### BACKGROUND

Conventionally, when a terminal, such as an e-book reader, a mobile phone, or a tablet computer, presents an electronic document to a reader, the terminal generally presents the document page by page, to provide the reader with a feeling close to reading a paper book. Different terminals may have different sizes of screens, and the same terminal can also set different sizes of text fonts.

However, there may be uninterruptible elements in the document, such as a picture. When there is no sufficient space remaining on an original page to present the picture, the picture is presented on a succeeding page to be displayed, which may cause a large blank area appearing on the original page.

### SUMMARY

According to a first aspect of the present disclosure, there is provided a method for a device to perform typesetting on a document, comprising: paginating the document into a plurality of pages; determining that a page of the plurality of pages contains a blank area after the paginating; determining an adjustable element in the document that causes the blank area; and transposing the adjustable element and an adjacent element in the document, to determine a typesetting sequence for the document.

According to a second aspect of the present disclosure, there is provided a device for performing typesetting on a document, comprising: a processor; and a memory for storing instructions executable by the processor, wherein the processor is configured to: paginate the document into a plurality of pages; determine that a page of the plurality of pages contains a blank area after the paginating; determine an adjustable element in the document that causes the blank area; and transpose the adjustable element and an adjacent element in the document, to determine a typesetting sequence for the document.

According to a third aspect of the present disclosure, there is provided a non-transitory computer-readable medium having stored therein instructions that, when executed by a processor of a device, cause the device to perform a method to perform typesetting on a document, the method comprising: paginating the document into a plurality of pages; determining that a page of the plurality of pages contains a blank area after the paginating; determining an adjustable element in the document that causes the blank area; and transposing the adjustable element and an adjacent element in the document, to determine a typesetting sequence for the document.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for a device to perform typesetting, according to an exemplary embodiment.

FIG. 2 is a flowchart of a method for a device to perform typesetting by adjusting backward an adjustable element, according to an exemplary embodiment.

FIG. 3 is a schematic view of a document after being paginated, according to an exemplary embodiment.

FIG. 4 is a schematic view of the document in FIG. 3 after adjusting backward an adjustable element and re-paginating, according to an exemplary embodiment.

FIG. 5 is a schematic view of the document in FIG. 3 after further adjusting backward the adjustable element and re-paginating, according to an exemplary embodiment.

FIG. 6 is a flowchart of a method for a device to perform typesetting by adjusting forward an adjustable element, according to an exemplary embodiment.

FIG. 7 is a schematic view of the document in FIG. 3 after adjusting forward an adjustable element and re-paginating, according to an exemplary embodiment.

FIG. 8 is a schematic view of the document in FIG. 3 after further adjusting forward the adjustable element and re-paginating, according to an exemplary embodiment.

FIG. 9 is a flowchart of a method for a device to perform typesetting by adjusting forward and backward an adjustable element, according to an exemplary embodiment.

FIG. 10 is a block diagram of a device for typesetting, according to an exemplary embodiment.

FIG. 11 is a block diagram of a device for typesetting, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

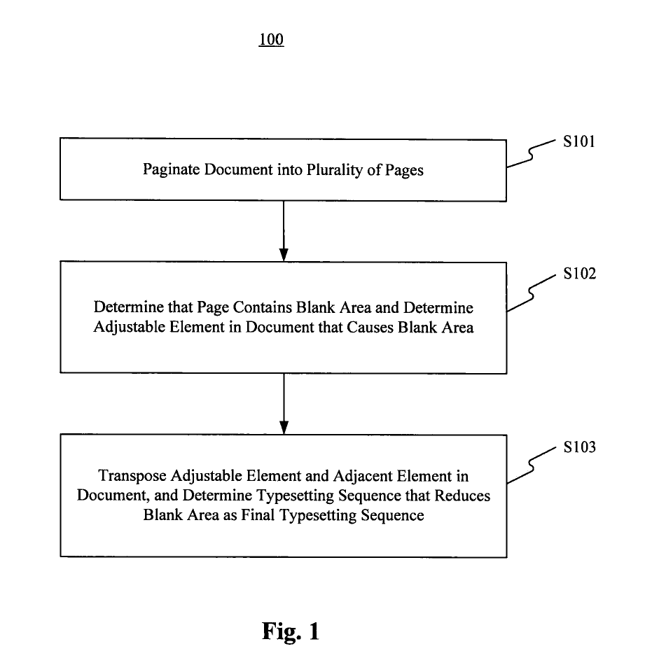

FIG. 1 is a flowchart of a method 100 for a device to perform typesetting, according to an exemplary embodiment. For example, the device may be an e-book reader, a mobile phone, a tablet computer, etc. Referring to FIG. 1, the method 100 includes the following steps.

In step S101, the device paginates a document into a plurality of pages. For example, the device obtains a number of characters to be displayed on a display of the device according to a screen size of the display and a font size of the characters, and then paginates the document according to the number of characters to be displayed on the display.

In step S102, the device determines that a page of the plurality of pages of the document contains a blank area after the paginating, and further determines an adjustable element in the document that causes the blank area.

Each separate part of the document is an element of the document. For example, a title, a paragraph of text, a picture, a table, a formula, a link, a gadget, etc., are each an element of the document.

An adjustable element refers to an element whose typesetting sequence in the document may be adjusted. Adjustable elements include but are not limited to: pictures, tables, formulas, etc., which can be transposed to be before or after, e.g., adjacent text. A title of the document, for example, is not an adjustable element because the title generally appears at the beginning of the document, and its typesetting sequence cannot be adjusted.

In exemplary embodiments, to determine that an adjustable element causes the blank area on the page, the device determines whether the first element on a page next to that page is an adjustable element and, if it is determined that the first element on the next page is an adjustable element, the device determines the first element as an adjustable element that causes the blank area.

In step S103, the device transposes the adjustable element and an adjacent element in the document, and determines a typesetting sequence that reduces the blank area as a final typesetting sequence.

For example, each adjustable element is assigned an adjusting range. An adjusting range refers to a number of times that the adjustable element can be transposed forward, e.g., moved toward a higher page number, or transposed backward, e.g., moved toward a lower page number. Changing a position of the adjustable element within the adjusting range of the adjustable element may reduce the blank area without destroying the logic in context of the document.

In exemplary embodiments, the device records a size, e.g., a height, of the blank area, and transposes the adjustable element and the adjacent element by transposing a typesetting sequence number of the adjustable element with that of its adjacent element. The typesetting sequence number of an element in the document is predetermined and used to indicate a relative position of that element in the document. The device further rearranges elements in the document according to the transposed typesetting sequence numbers. The device then re-paginates a portion of the document beginning from a page including the element preceding the adjustable element, and determines if a size of the blank area after the re-paginating is smaller than the previously recorded size of the blank area. If the device determines that the size of the blank area after the re-paginating is smaller than the previously recorded size, the device determines a typesetting sequence according to the transposed typesetting sequence numbers as a final typesetting sequence for the document. Otherwise, the device transposes the adjustable element and its next adjacent element and repeats the re-paginating, until the blank area becomes smaller than the previously recorded size.

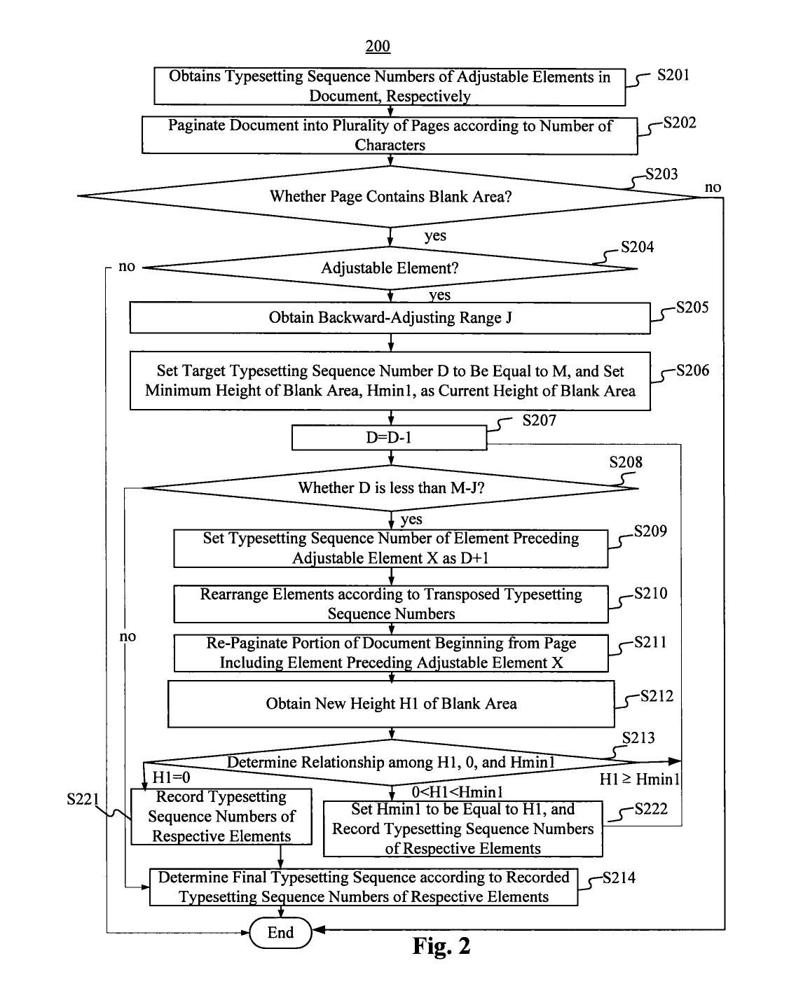

FIG. 2 is a flowchart of a method 200 for the device to perform typesetting by adjusting backward an adjustable element, according to an exemplary embodiment. Referring to FIG. 2, the method 200 includes the following steps.

In step S201, the device obtains typesetting sequence numbers of adjustable elements in a document, respectively. For example, elements of the document may be classified in advance, such as each element being classified into a title, a text, a picture, etc. In the illustrated embodiment, pictures are considered adjustable elements.

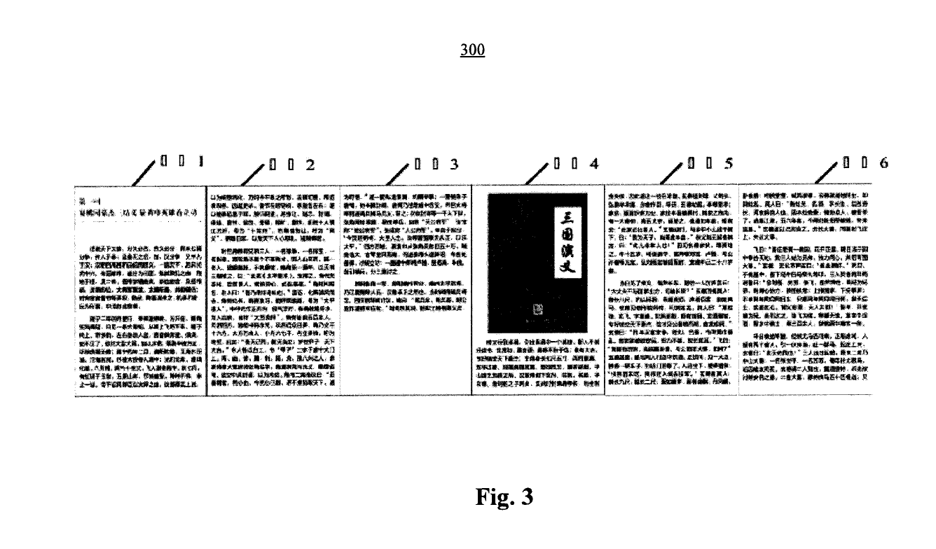

In step S202, the device paginates the document into a plurality of pages according to a number of characters to be displayed on the display of the device. For example FIG. 3 shows a schematic view of a Chinese language document 300 after being paginated, including 6 consecutive pages: page 001 to page 006, according to an exemplary embodiment.

Referring to FIGS. 2 and 3, in step S203, the device determines whether a page of the plurality of pages of the document contains a blank area after the paginating, and if so, the device performs step S204; otherwise, the method 200 ends. For example, in performing step S203, the device determines whether a height of a blank area is greater than a preset threshold. If the device determines that the height of the blank area is greater than the preset threshold, the device performs the following steps to reduce the height of the blank area to be less than or equal to the preset threshold.

For example, as shown in FIG. 3, the device determines that page 003 of the document 300 contains a blank area having a height greater than a predetermined threshold.

In step S204, the device determines whether the first element on the page succeeding the page that contains the blank area is an adjustable element, referred to herein as an adjustable element X, according to a typesetting sequence number M of the first element on the succeeding page and the typesetting sequence numbers of the adjustable elements obtained in step S201. If it is determined that the first element on the succeeding page is an adjustable element, the device performs step S205; otherwise, the method 200 ends.

For example, as shown in the FIG. 3, the first element on the page succeeding page 003, i.e., page 004, is a picture. In the illustrated embodiment, the typesetting sequence number M of the picture is 6, and the typesetting sequence numbers obtained in the step S201 include 6. Accordingly, the device determines the picture as the adjustable element X.

In step S205, the device obtains a backward-adjusting range J of the adjustable element X. The backward-adjusting range J represents a range within which the adjustable element X may be adjusted backward, e.g., a number of times that the adjustable element X may be transposed with a preceding adjacent element.

In the illustrated embodiment, the backward-adjusting range J of the adjustable element X in FIG. 3 is set to be 3.

In step S206, the device sets a target typesetting sequence number D of the adjustable element X to be equal to the typesetting sequence number M of the first element on the succeeding page, and sets a minimum height of the blank area, Hmin1, as a current height of the blank area.

In step S207, the device reduces the target typesetting sequence number D by one, i.e., D=D−1.

In step S208, the device determines whether the target typesetting sequence number D is less than M−J. If so, the device performs step S209; otherwise, the device performs step S214.

In step S209, the device sets a typesetting sequence number of the element preceding the adjustable element X as D+1. In other words, the device transposes the typesetting sequence number of the adjustable element X and the typesetting sequence number of the element preceding the adjustable element X.

In step S210, the device rearranges the elements of which the typesetting sequence numbers have changed, i.e., the adjustable element X and the element preceding the adjustable element X, according to the transposed typesetting sequence numbers.

In step S211, the device re-paginates a portion of the document beginning from the page including the element preceding the adjustable element X.

In step S212, the device obtains a new height H1 of the blank area.

In step S213, the device determines a relationship among H1, 0, and Hmin1. If the device determines that H1 is equal to 0, the device records the typesetting sequence numbers of respective elements (step S221) and then performs step S214. If the device determines that H1 is greater than or equal to Hmin1, the device performs step S207. If the device determines that H1 is less than Hmin1 and does not equal to 0, the device sets Hmin1 to be equal to H1, records the typesetting sequence numbers of respective elements (step S222), and then performs step S207.

In step S214, the device determines the final typesetting sequence for the document according to the recorded typesetting sequence numbers of respective elements.

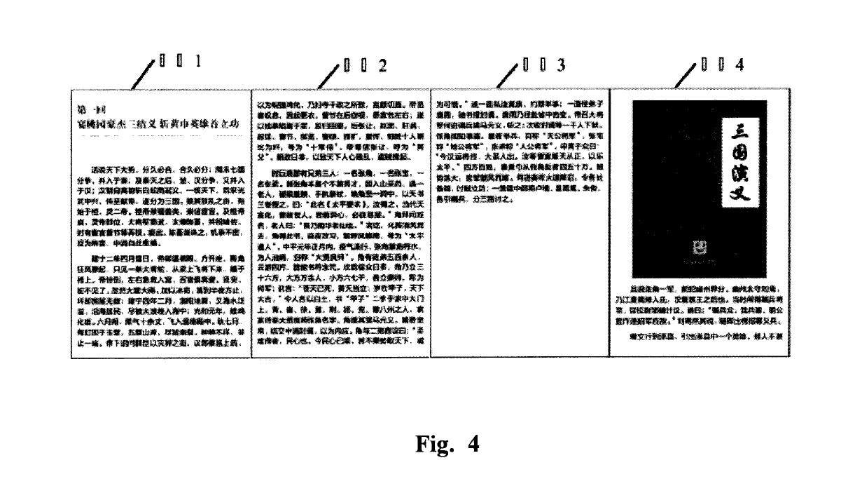

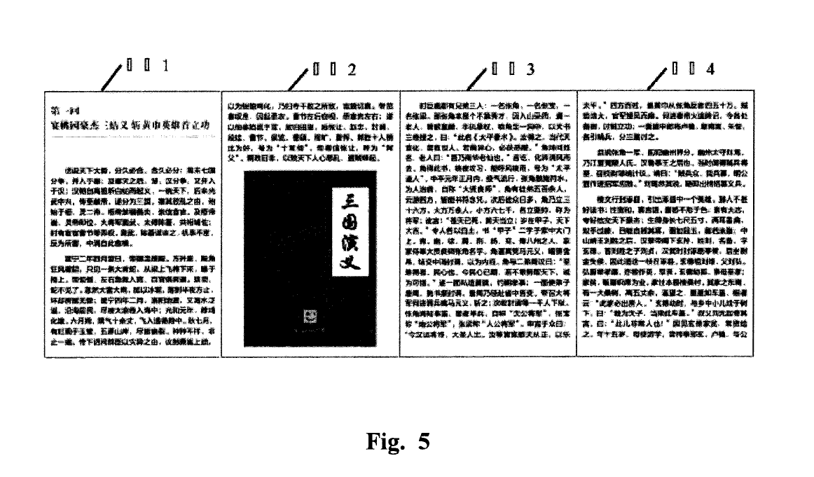

FIGS. 4 and 5 illustrate an example in which the method 200 is applied to the document 300 in FIG. 3, according to an exemplary embodiment. Referring to FIGS. 3-5, the picture on page 004 in FIG. 3 is determined as the adjustable element X, and the adjustable range of the picture is set as J=3. Firstly, the device adjusts backward the picture by transposing the picture and the paragraph preceding the picture, as illustrated in FIG. 4. Accordingly, the typesetting sequence number of the picture in the document changes from 6 to 5. Because the device determines that the height of the blank area is still larger than the preset threshold, i.e., the blank area on the page 3 still exists, the device further adjusts backward the picture by transposing the picture and the next paragraph preceding the picture, as illustrated in FIG. 5. Accordingly, the typesetting sequence number of the picture in the document changes from 5 to 4, and at this time, the device determines that no blank area exists on page 003. As a result, the typesetting sequence number of the element with the original typesetting sequence number 6, i.e., the picture, changes to 4, the typesetting sequence number of the element with the original typesetting sequence number 4, i.e., the second transposed paragraph, changes to 5, and the typesetting sequence number of the element with the original typesetting sequence number 5, i.e., the first transposed paragraph, changes to 6.

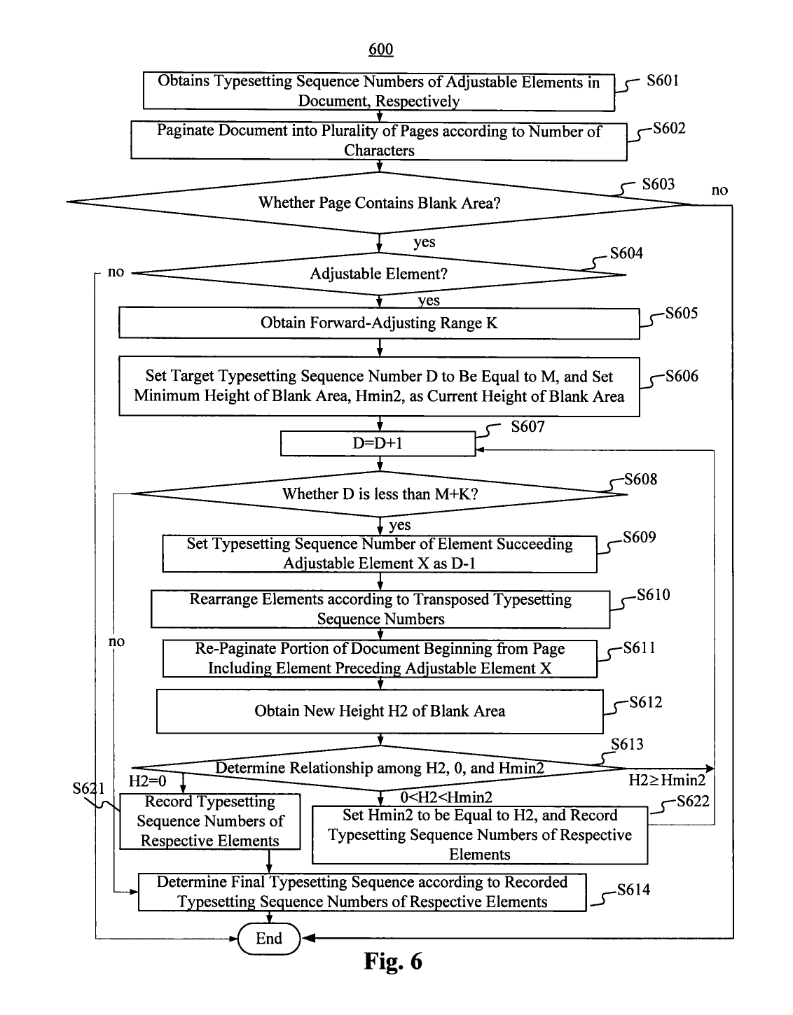

FIG. 6 is a flowchart of a method 600 for a device to perform typesetting by adjusting forward an adjustable element, according to an exemplary embodiment. Referring to FIG. 6, the method 600 includes the following steps.

In step S601, the device obtains typesetting sequence numbers of adjustable elements in a document, respectively.

In step S602, the device paginates the document into a plurality of pages according to a number of characters to be displayed on a display of the device. For example, FIG. 3 shows the schematic view of the document 300 after being paginated.

Referring to FIGS. 3 and 6, in step S603, the device determines whether a page of the plurality of pages of the document contains a blank area after the paginating and, if so, the device performs step S604; otherwise, the method 600 ends. For example, as shown in FIG. 3, the device determines that page 003 of the document 300 contains a blank area.

In step S604, the device determines whether the first element on the page succeeding the page that contains the blank area is an adjustable element, referred to herein as an adjustable element X, according to a typesetting sequence number M of the first element on the succeeding page and the typesetting sequence numbers of the adjustable elements obtained in the step S601. If it is determined that the first element on the succeeding page is an adjustable element, the device performs step S605; otherwise, the method 600 ends.

For example, as shown in the FIG. 3, the first element on the page succeeding page 003, i.e., page 004, is a picture. In the illustrated embodiment, the typesetting sequence number M of the picture is 6, and the typesetting sequence numbers obtained in step S601 include 6. Accordingly, the device determines the picture as the adjustable element X.

In step S605, the device obtains a forward-adjusting range K of the adjustable element X. The forward-adjusting range K represents a range within which the adjustable element X may be adjusted forward, e.g., a number of times that the adjustable element X may be transposed with a succeeding adjacent element.

In the illustrated embodiment, the forward-adjusting range K of the adjustable element X in FIG. 3 is set to be 3.

In step S606, the device sets a target typesetting sequence number D of the adjustable element X to be equal to the typesetting sequence number M of the first element on the succeeding page, and sets a minimum height of the blank area, Hmin2, as a current height of the blank area.

In step S607, the device increases the target typesetting sequence number D by one, i.e., D=D+1.

In step S608, the device determines whether the target typesetting sequence number D is less than M+K, and if so, the device performs step S609; otherwise, the device performs step S614.

In step S609, the device sets a typesetting sequence number of the element succeeding the adjustable element X as D−1. In other words, the device transposes the typesetting sequence number of the adjustable element X and the typesetting sequence number of the element succeeding the adjustable element X.

In step S610, the device rearranges the elements of which sequence numbers have changed, i.e., the adjustable element X and the element succeeding the adjustable element X, according to the transposed typesetting sequence numbers.

In step S611, the device re-paginates a portion of the document beginning from the page containing the element preceding the adjustable element X.

In step S612, the device obtains a new height H2 of the blank area.

In step S613, the device determines a relationship among H2, 0, and Hmin2. If the device determines that H2 is equal to 0, the device records the typesetting sequences of respective elements (step S621) and then performs step S614. If the device determines that H2 is greater than or equal to Hmin2, the device performs step S607. If the device determines that H2 is greater than 0 and less than Hmin2, the device sets Hmin2 to be equal to H2, records the typesetting sequence numbers of respective elements (step S622), and then performs step S607.

In step S614, the device determines the final typesetting sequence for the document according to the recorded typesetting sequence numbers of respective elements.

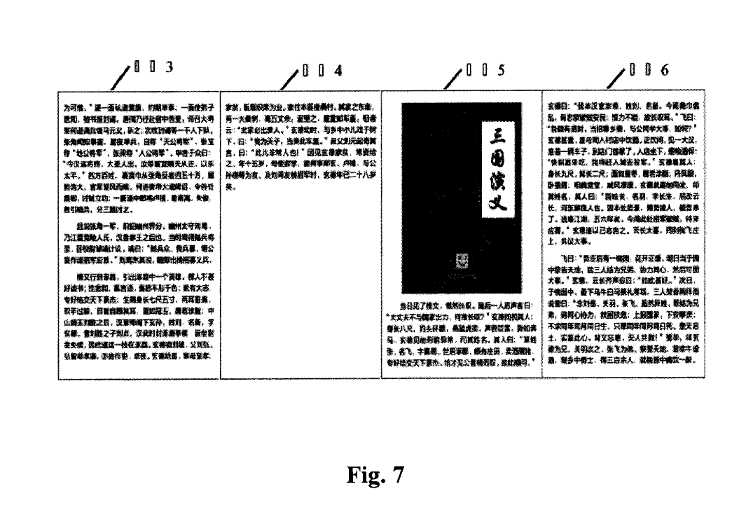

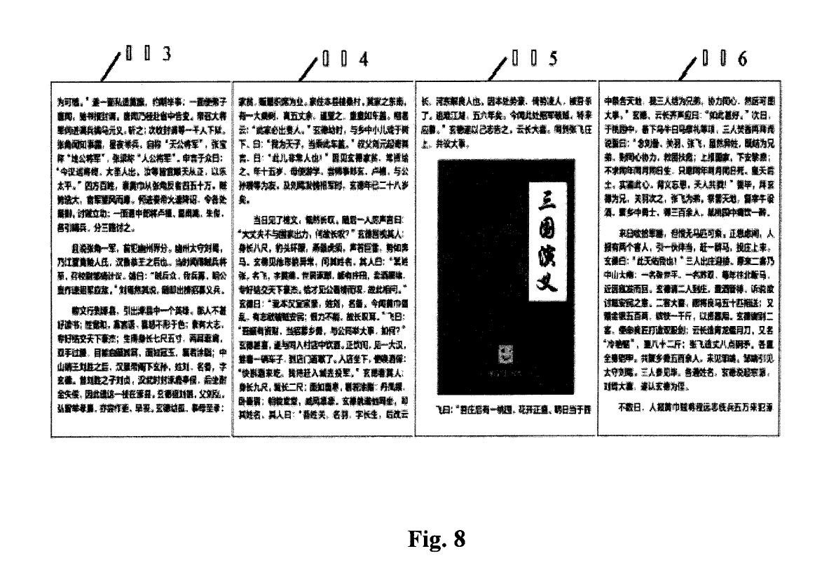

FIGS. 7 and 8 illustrate an example in which the method 600 is applied to the document 300 in FIG. 3, according to an exemplary embodiment. Referring to FIGS. 3, 7, and 8, the picture on page 004 in FIG. 3 is determined as the adjustable element X, and the adjustable range of the picture is set as K=3. Firstly, the device adjusts forward the picture by transposing the picture and the paragraph succeeding the picture, as illustrated in FIG. 7. Accordingly, the typesetting sequence number of the picture in the document changes from 6 to 7. Because the device determines that the height of the blank area before the picture is still larger than the preset threshold, i.e., the blank area still exists, the device further adjusts forward the picture by transposing the picture and the next paragraph succeeding the picture, as illustrated in FIG. 8. Accordingly, the typesetting sequence number of the picture in the document changes from 7 to 8, and at this time, the device determines that no blank area exists.

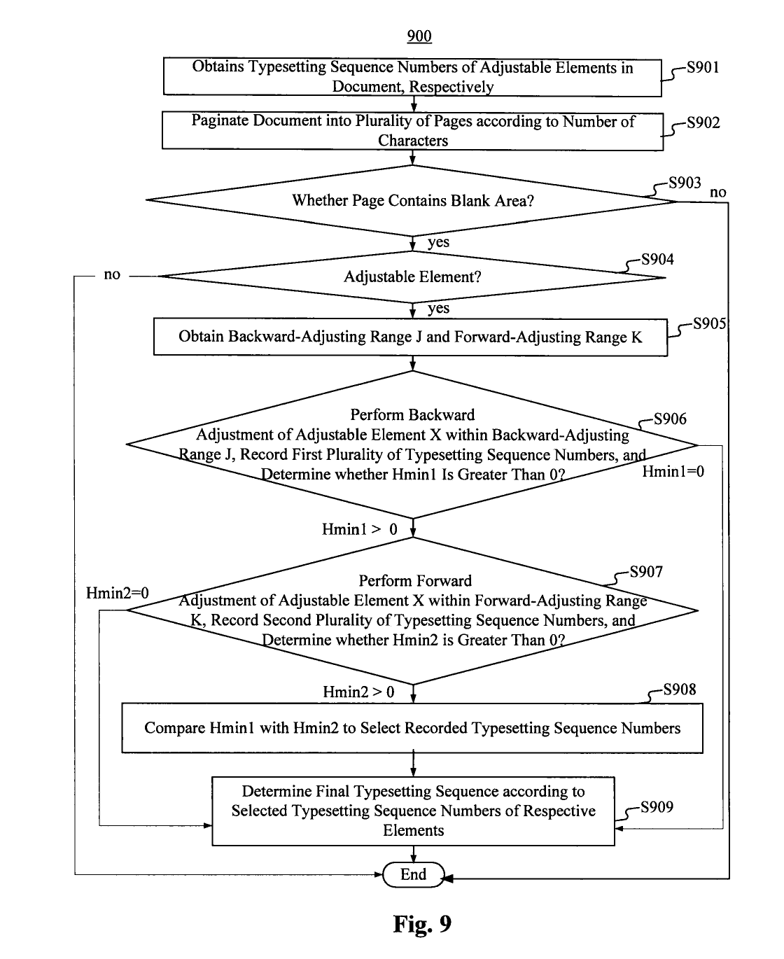

FIG. 9 is a flowchart of a method 900 for a device to perform typesetting by adjusting forward or backward an adjustable element, according to an exemplary embodiment. Referring to FIG. 9, the method 900 includes the following steps:

In step S901, the device obtains typesetting sequence numbers of adjustable elements in a document, respectively.

In step S902, the device paginates the document into a plurality of pages according to a number of characters to be displayed on a display of the device.

In step S903, the device determines whether a page of the plurality of pages contains a blank area after the paginating, and if so, the device performs step S904; otherwise, the method 900 ends.

In step S904, the device determines whether the first element on the page succeeding the page that contains the blank area is an adjustable element, referred to herein as an adjustable element X, according to a typesetting sequence number M of the first element on succeeding page and the typesetting sequence numbers of the adjustable elements obtained in the step S901. If it is determined that the first element on the succeeding page is an adjustable element, the device performs step S905; otherwise, the method 900 ends.

In step S905, the device obtains a backward-adjusting range J and a forward-adjusting range K of the adjustable element X.

In step S906, the device performs a backward adjustment of the adjustable element X within the backward-adjusting range J, similar to the description above in connection with the method 200 in FIG. 2, and records a first plurality of typesetting sequence numbers of respective elements corresponding to a reduced size, Hmin1, of the blank area, such as determined in step S222 (FIG. 2). The device further determines if the blank area still exists by determining, e.g., if Hmin1 is greater than 0 and, if so, the device performs step S907; otherwise, the device selects the first plurality of typesetting sequence numbers to perform step S909.

In step S907, the device performs a forward adjustment of the adjustable element X within the forward-adjusting range K, similar to the description above in connection with FIG. 6, and records a second plurality of typesetting sequence numbers of respective elements corresponding to a reduced size, Hmin2, of the blank area, such as determined in step S622 (FIG. 6). The device further determines if Hmin2 is greater than 0 and, if so, the device performs step S908; otherwise, the device performs step S909.

In step S908, the device compares Hmin1 with Hmin2 to select the first plurality or the second plurality of recorded typesetting sequence numbers. If Hmin1 is less than Hmin2, the device selects the first plurality of typesetting sequence numbers corresponding to Hmin1. If Hmin1 is greater than Hmin2, the device selects the second plurality of typesetting sequence numbers corresponding to Hmin2. If Hmin1 is equal to Hmin2, the device selects the first plurality or the second plurality of typesetting sequence numbers.

In step S909, the device determines the final typesetting sequence for the document according to the selected typesetting sequence numbers of respective elements.

In the illustrated embodiment, the device performs Step S906 before performing Step S907. Alternatively, the device can perform Step S907 before performing Step S906.

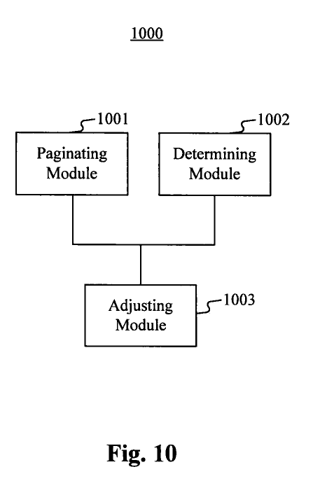

FIG. 10 is a block diagram of a device 1000 for performing typesetting on a document, according to an exemplary embodiment. Referring to FIG. 10, the device 1000 includes a paginating module 1001, a determining module 1002, and an adjusting module 1003.

In exemplary embodiments, the paginating module 1001 is configured to paginate a document into a plurality of pages. The determining module 1002 is configured to determine an adjustable element in the document that causes a blank area after the paginating. The adjusting module 1003 is configured to adjust a typesetting sequence of the adjustable element and an adjacent element, and to determine a final typesetting sequence that reduces the blank area.

In one exemplary embodiment, the adjusting module 1003 includes a transposing unit, configured to transpose a typesetting sequence number of the adjustable element and that of an adjacent element; an arranging unit, configured to rearrange the elements in the document according to the transposed typesetting sequence numbers; and a paginating unit, configured to re-paginate a portion of the document beginning from the page including the element preceding the adjustable element.

In one exemplary embodiment, the adjusting module 1003 further includes a recording unit configured to record a size of the blank area after the paginating; and a determining unit configured to determine a typesetting sequence of the elements in the document, to make the size of the blank area equal to or less than a preset threshold. For example, the adjusting module 1003 is configured to transpose the adjustable element and an adjacent element in the document within an adjusting range of the adjustable element, to reduce the blank area. The adjusting range includes a forward-adjusting range and a backward-adjusting range.

In exemplary embodiments, the paginating module 1001 includes an obtaining unit configured to obtain a number of characters to be displayed on a display of the device 1000, according to a size of the display and a font size of the characters; and a paginating unit configured to paginate the document into a plurality of pages according to the number of characters to be displayed on the display.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

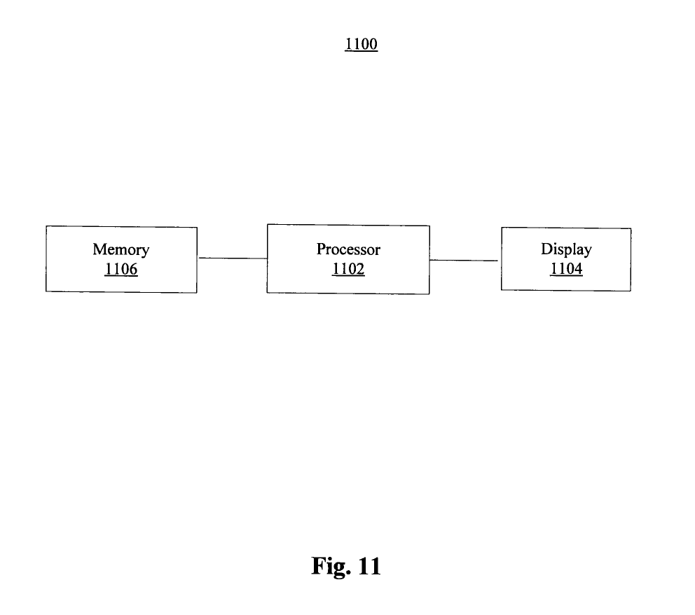

FIG. 11 is a block diagram of a device 1100 for performing typesetting on a document, according to an exemplary embodiment. Referring to FIG. 11, the device 1100 includes a processor 1102 and a display 1104. The device 1100 also includes memory resources, represented by a memory 1106 for storing data as well as for storing program instructions and otherwise facilitating operation of the processor 1102. In exemplary embodiments, there is also provided a non-transitory readable storage medium including instructions, such as included in the memory 1106, executable by the processor 1102 in the terminal 1100, for performing the above-described methods.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a device to perform typesetting on a document, comprising:
paginating the document into a plurality of pages;
determining that a page of the plurality of pages contains a blank area after the paginating;
determining an adjustable element in the document that causes the blank area; and
transposing the adjustable element and an adjacent element in the document, to determine a typesetting sequence for the document.

2. The method according to claim 1, further comprising:
determining if a size of the blank area is reduced after the transposing; and
determining a sequence of elements in the document after the transposing as the typesetting sequence for the document, if it is determined that the size of the blank area is reduced.

3. The method according to claim 2, wherein determining if the size of the blank area is reduced after the transposing comprises:
determining if the size of the blank area after the transposing is smaller than or equal to a preset threshold.

4. The method according to claim 1, wherein the transposing comprises:
transposing a typesetting sequence number of the adjustable element and a typesetting sequence number of the adjacent element;
rearranging elements in the document according to the transposed typesetting sequence numbers; and
re-paginating a portion of the document beginning from a page including an element preceding the adjustable element.

5. The method according to claim 1, wherein the transposing comprises:
transposing the adjustable element within a predetermined adjusting range.

6. The method according to claim 1, wherein the transposing comprises at least one of:
transposing the adjustable element and an element preceding the adjustable element in the document; or
transposing the adjustable element and an element succeeding the adjustable element in the document.

7. The method according to claim 1, wherein the paginating comprises:
obtaining a number of characters in the document to be displayed on a display of the device according to a size of the display and a front size of the characters; and
paginating the document according to the number of characters to be displayed on the display.

8. A device for performing typesetting on a document, comprising:
a processor; and
a memory for storing instructions executable by the processor,
wherein the processor is configured to:
paginate the document into a plurality of pages;
determine that a page of the plurality of pages contains a blank area after the paginating;
determine an adjustable element in the document that causes the blank area; and
transpose the adjustable element and an adjacent element in the document, to determine a typesetting sequence for the document.

9. The device according to claim 8, wherein the processor is further configured to:
determine if a size of the blank area is reduced after the transposing; and
determine a sequence of elements in the document after the transposing as the typesetting sequence for the document, if it is determined that the size of the blank area is reduced.

10. The device according to claim 9, wherein the processor is further configured to:
determine if the size of the blank area after the transposing is smaller than or equal to a preset threshold.

11. The device according to claim 8, wherein the processor is further configured to:
transpose a typesetting sequence number of the adjustable element and a typesetting sequence number of the adjacent element;
rearrange elements in the document according to the transposed typesetting sequence numbers; and
re-paginate a portion of the document beginning from a page including an element preceding the adjustable element.

12. The device according to claim 8, wherein the processor is further configured to:
transpose the adjustable element within a predetermined adjusting range.

13. The device according to claim 8, wherein the processor is further configured to perform at least one of:
transposing the adjustable element and an element preceding the adjustable element in the document; or
transposing the adjustable element and an element succeeding the adjustable element in the document.

14. The device according to claim 8, further comprising:
a display,
wherein the processor is further configured to:
obtain a number of characters in the document to be displayed on the display according to a size of the display and a front size of the characters; and
paginate the document according to the number of characters to be displayed on the display.

15. A non-transitory computer-readable medium having stored therein instructions that, when executed by a processor of a device, cause the device to perform a method to perform typesetting on a document, the method comprising:
paginating the document into a plurality of pages;
determining that a page of the plurality of pages contains a blank area after the paginating;
determining an adjustable element in the document that causes the blank area; and
transposing the adjustable element and an adjacent element in the document, to determine a typesetting sequence for the document.

16. The non-transitory computer-readable medium according to claim 15, wherein the method further comprises:
determining if a size of the blank area is reduced after the transposing; and
determining a sequence of elements in the document after the transposing as the typesetting sequence for the document, if it is determined that the size of the blank area is reduced.

17. The non-transitory computer-readable medium according to claim 16, wherein determining if the size of the blank area is reduced after the transposing comprises:
determining if the size of the blank area after the transposing is smaller than or equal to a preset threshold.

18. The non-transitory computer-readable medium according to claim 15, wherein the transposing comprises:
transposing a typesetting sequence number of the adjustable element and a typesetting sequence number of the adjacent element;
rearranging elements in the document according to the transposed typesetting sequence numbers; and
re-paginating a portion of the document beginning from a page including an element preceding the adjustable element.

19. The non-transitory computer-readable medium according to claim 15, wherein the transposing comprises:
transposing the adjustable element within a predetermined adjusting range.

20. The non-transitory computer-readable medium according to claim 15, wherein the transposing comprises at least one of:
transposing the adjustable element and an element preceding the adjustable element in the document; or
transposing the adjustable element and an element succeeding the adjustable element in the document.
